(19) United States
(12) Patent Application Publication
(10) Pub. No.: US 2017/0185667 A1
(43) Pub. Date: Jun. 29, 2017

(54) Content classification

(71) Applicant: McAfee, Inc., Santa Clara, CA (US)

(72) Inventors: Nidhi Singh, Tuebingen (DE); Craig Philip Olinsky, Paderborn (DE)

(73) Assignee: McAfee, Inc., Santa Clara, CA (US)

(21) Appl. No.: 14/998,165

(22) Filed: Dec. 24, 2015

(51) Int. Cl. G06F 17/30; G06N 99/00

(52) U.S. Cl. CPC G06F 17/30598; G06F 17/30424; G06N 99/005

(57) ABSTRACT

Particular embodiments described herein provide for an electronic device that can be configured to analyze data using an ensemble and assign a classification to the data based, at least in part, on the results of the analyses using the ensemble. The ensemble can include one or more multinomial classifiers and each multinomial classifier can assign two or more classifications to the data.

### TECHNICAL FIELD

This disclosure relates in general to the field of information security, and more particularly, to content classification.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from, the host computer, etc. Several attempts to identify malware rely on the proper classification of data. However, it can be difficult and time consuming to properly classify large amounts of data. Hence, significant administrative challenges remain for protecting computers and computer networks from malicious and inadvertent exploitation by malicious software and devices.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for content classification in accordance with an embodiment of the present disclosure;

FIG. 2 is a simplified flowchart illustrating potential operations that may be associated with the communication system in accordance with an embodiment;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a block diagram illustrating an example computing system that is arranged in a point-to-point configuration in accordance with an embodiment;

FIG. 7 is a simplified block diagram associated with an example ARM ecosystem system on chip (SOC) of the present disclosure; and

FIG. 8 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

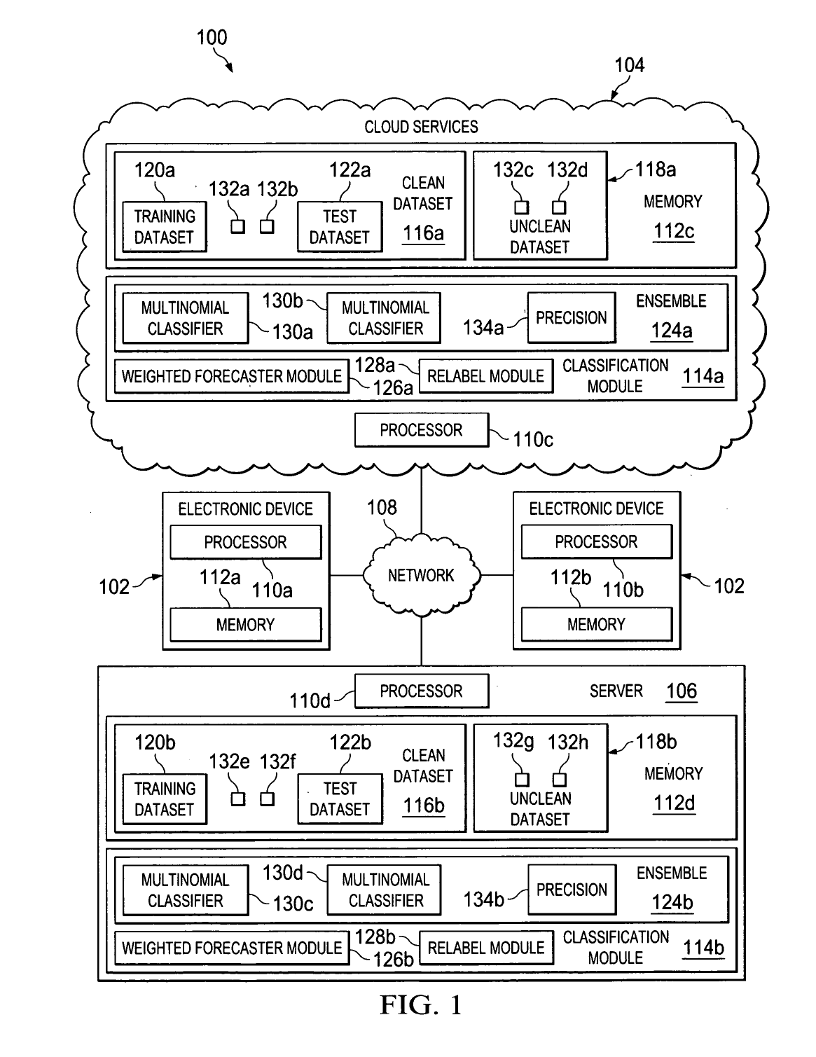

FIG. 1 is a simplified block diagram of a communication system 100 for content classification in accordance with an embodiment of the present disclosure. As illustrated in FIG. 1, an embodiment of communication system 100 can include one or more electronic devices 102, cloud services 104, and a server 106. Each electronic device 102 can include a processor 110a and 110b and memory 112a and 112b respectively.

Cloud services 104 can include a processor 110c, memory 112c, and a classification module 114a. Memory 112c can include a clean dataset 116a and an unclean dataset 118a. Clean dataset 116a can include a training dataset 120a, a test dataset 122a, and one or more instances 132a and 132b. Unclean dataset 118a can include one or more instances 132c and 132d. Classification module 114a can include an ensemble 124a, a weighted forecaster module 126a, and a relabel module 128a. Ensemble 124a can include one or more multinomial classifiers 130a and 130b and a precision 134a. In an example, classification module 114a can include a plurality of ensembles and each ensemble can include a plurality of multinomial classifiers.

Server 106 can include a processor 110d, memory 112d, and a classification module 114b. Memory 112d can include a clean dataset 116b and an unclean dataset 118b. Clean dataset 116b can include a training dataset 120b, a test dataset 122b, and one or more instances 132e and 132f. Unclean dataset 118b can include one or more instances 132g and 132h. Classification module 114b can include an ensemble 124b, a weighted forecaster module 126b and a relabel module 128b. Ensemble 124b can include one or more multinomial classifiers 130c and 130d and a precision 134b. In an example, ensemble 124b includes a plurality of multinomial classifiers. Electronic device 102, cloud services 104, and server 106 may be in communication using network 108.

Clean datasets 116a and 116b can include a plurality of datasets with a known and trusted classification, category, or label. As used herein, the terms “classification,” “category,” and “label” are synonymous and each can be used to describe data that includes a common feature or element or a dataset where data in the dataset includes a common feature or element. Unclean datasets 118a and 118b can include a plurality of datasets that include a classification that may or may not be correct. Unclean datasets 118a and 118b can also include datasets that do not have any classification. Instances 132a-132f may be instances of data in a dataset. Classification modules 114a and 114b can be configured to create one or more multinomial classifiers and one or more ensembles using data from clean data sets 116a and 116b. Classification modules 114a and 114b can also be configured to analyze data in unclean datasets 118a and 118b and assign a classification to the dataset. More specifically, using ensembles 124a and 124b and weighted forecaster module 126a and 126b a classification can be assigned to instances in unclean datasets 118a and 118b. Relabel modules 128a and 128b can determine if a classification assigned to the instances needs to be changed.

Elements of FIG. 1 may be coupled to one another through one or more interfaces employing any suitable connections (wired or wireless), which provide viable pathways for network (e.g., network 108) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Some current systems can have a large amount of categorized data or data that has been assigned a classification. However, sometimes the data is mischaracterized or incorrectly categorized or classified. For large scales systems, this can result in hundreds of thousands or millions of instances of data that is mischaracterized. Data that is mischaracterized can create significant problems when attempting to sort or analyze the data and when attempting to identify or analyze malware. Some solutions typically address this problem by using methods that involve human intervention. However, such a solution of using human intervention is not feasible in a large-scale collection of data as the man hours required to analyze the data can be cost prohibitive.

A communication system for content classification, as outlined in FIG. 1, can resolve these issues (and others). Communication system 100 may be configured to use ensemble learning where multiple algorithms (or experts) are compounded in a well-defined manner to produce a final predicted value such as a classification. In an example, a clean dataset can be divided into a training data set (e.g., training data set 120a) and test data set (e.g., test dataset 122a). Using the training data set, the system can iteratively build a set of logistic regression based algorithms (e.g., multinomial classifiers 130a and 130b) which are combined together to form an ensemble (e.g., ensemble 124a). Each algorithm can be assigned a weight (e.g., precision 134a) depending on its accuracy (i.e., higher the accuracy, more the weight), and the weights can be updated iteratively using an exponentially weighted forecaster. The compound prediction of these algorithms (e.g., ensemble prediction) can then be used to identify, in a three-stage procedure, if the existing classification of an instance/data in the given large-scale corpus is correct or not. If found incorrect, then using the probabilistic ensemble prediction, the system can estimate the correct classification for the data and replace the old incorrect classification with the new correct classification.

Previous solutions to content cleansing required a fair degree of human intervention, which is not feasible for large-scale problem scenarios. In contrast, once implemented, communication system 100 can be completely automated and does not require any human intervention. Given a large corpus of documents, in which each document had been initially assigned a classification either by a human or by a software, communication system 100 can be configured to verify if the assigned classification of each document is correct, and if incorrect, determine the correct classification and replace the old incorrect classification with the new correct classification. The use of ensemble learning, which makes use of and combines multiple algorithms to produce a final output, can be more robust than single algorithm based approaches.

In an example Stage 1, communication system 100 can be configured to partition a clean dataset into a training dataset and a test dataset. The training dataset can be used to build an initial multinomial classifier. The multinomial classifier is able to provide multiple classifications data. This initial multinomial classifier can be added to an ensemble. The ensemble can include multiple multinomial classifiers.

Using the test dataset, communication system 100 can determine a precision of the current ensemble for each classification and store the precision it in a vector (e.g., precision 134a and 134b). For example, an instance 132c from an unclean dataset 118a can be read and a probabilistic prediction using ensemble 124a can be determined for each classification (i.e., with what probability may instance 132c belong to each classification). In an example, an exponential weighted forecaster may be used. If for instance 132c, the probability of a predicted best classification is greater than a respective classification threshold in T, or the predicted best classification is the same as the existing classification in unclean dataset 118a, then the system can update training dataset 120a by adding instance 132c to the training dataset and instance 132c can be removed from unclean dataset 118a. The process can be repeated for each instance in unclean dataset 118a until the system has read and analyzed or processed each instance in unclean dataset 118a.

Using threshold T, allows the training dataset to be updated with clean instances extracted from the unclean dataset while the unclean dataset is left with lesser instances that are yet to be processed/cleansed. The updated training dataset can be used to build a new multinomial classifier and add it to the ensemble. The precision of the new classifier can be determined using the test dataset for each classification. If the precision of the updated ensemble is worse than that of the old ensemble for any classification (e.g., by more than 1%,) then the ensemble can be classified as ready and validated. If not, then a weight can be assigned to the new classifier in accordance with its overall precision and the weights of the existing classifiers in the ensemble can be normalized such that, for mathematical convenience, the sum of all classifiers in the ensemble adds up to one. Note that the sum of all the classifier in the ensemble could be normalized to add to one hundred; five hundred, two, or any other number. Using the updated (and bigger) ensemble of classifiers, remaining instances in the unclean dataset can be tested and re-classified if necessary. This creates an enhanced clean training dataset and reduces the unclean dataset.

In an example Stage 2, using the validated training set on the reduced unclean dataset, different probability thresholds for each classification, denoted by 12 can be used. The thresholds defined in 12 are not as strict, looser, or otherwise not as high of a threshold as compared to thresholds in T. In an example, an instance from the unclean dataset is analyzed. The system can select n (e.g., n=3) predicted best classifications, and their respective probabilities. If for instance 132c, the probability of any of the selected n classifications is greater than the respective thresholds in T₂, or the existing classification matches any of the selected n classifications, then training dataset 120a can be updated by adding instance 132c and instance 132c can be removed from unclean dataset 118a. This can further enhance training dataset 120a and further reduced unclean dataset 118a.

In an example Stage 3, the process is similar to example Stage 1, with the difference that in example Stage 3, the instances in the unclean dataset may not be re-classified but instead the existing classification can be validated in the unclean dataset. The resultant updated training dataset from Stage 2 can be run with different probability thresholds for each classification, denoted by T₃, which are not as strict, looser, or otherwise not as high of a threshold as compared to thresholds in T₂ that were used in example Stage 2. In an example, an instance from the unclean dataset is analyzed. For example, the existing classification of instance 132c may be recorded. The system can compute the predicted probability for the existing classification using the ensemble, and if the probability is greater than the respective classification threshold in T₃ and matches the recorded existing classification for instance 132c, then the system can update the training dataset by adding instance 132c and the system can remove instance 132c from the unclean dataset. The result is a large set of cleansed instances that are extracted from the given unclean dataset. It is of note that there can always be some small number of instances for which the ensemble may not have sufficiently high probabilistic scores required to re-classify them, and hence those instances may not be re-classified by the ensemble.

Turning to the infrastructure of FIG. 1, communication system 100 in accordance with an example embodiment is shown. Generally, communication system 100 can be implemented in any type or topology of networks. Network 108 represents a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic devices 102, cloud services 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, electronic devices 102, cloud services 104, and server 106 can include memory elements (e.g., memory 112a-d) for storing information to be used in the operations outlined herein. Electronic devices 102, cloud services 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic devices 102, cloud services 104, and server 106 may include software modules (e.g., classification modules 114a and 114b, weighted forecaster modules 126a and 126b, and relabel modules 128a and 128b) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, electronic devices 102, cloud services 104, and server 106 may include a processor (e.g., processor 110a-110d) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic devices 102 can be a network element and include, for example, desktop computers, laptop computers, mobile devices, personal digital assistants, smartphones, tablets, or other similar devices. Cloud services 104 is configured to provide cloud services to electronic devices 102. Cloud services may generally be defined as the use of computing resources that are delivered as a service over a network, such as the Internet. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication system 100. Although classification modules 114a and 114b, weighted forecaster modules 126a and 126b, and relabel modules 128a and 128b are illustrated as being located in cloud services 104 and server 106 respectively, this is for illustrative purposes only. Classification modules 114a and 114b, weighted forecaster modules 126a and 126b, and relabel modules 128a and 128b could be combined or separated in any suitable configuration. Furthermore, classification modules 114a and 114b, weighted forecaster modules 126a and 126b, and relabel modules 128a and 128b could be integrated with or distributed in another network accessible by electronic devices 102, cloud services 104, and server 106.

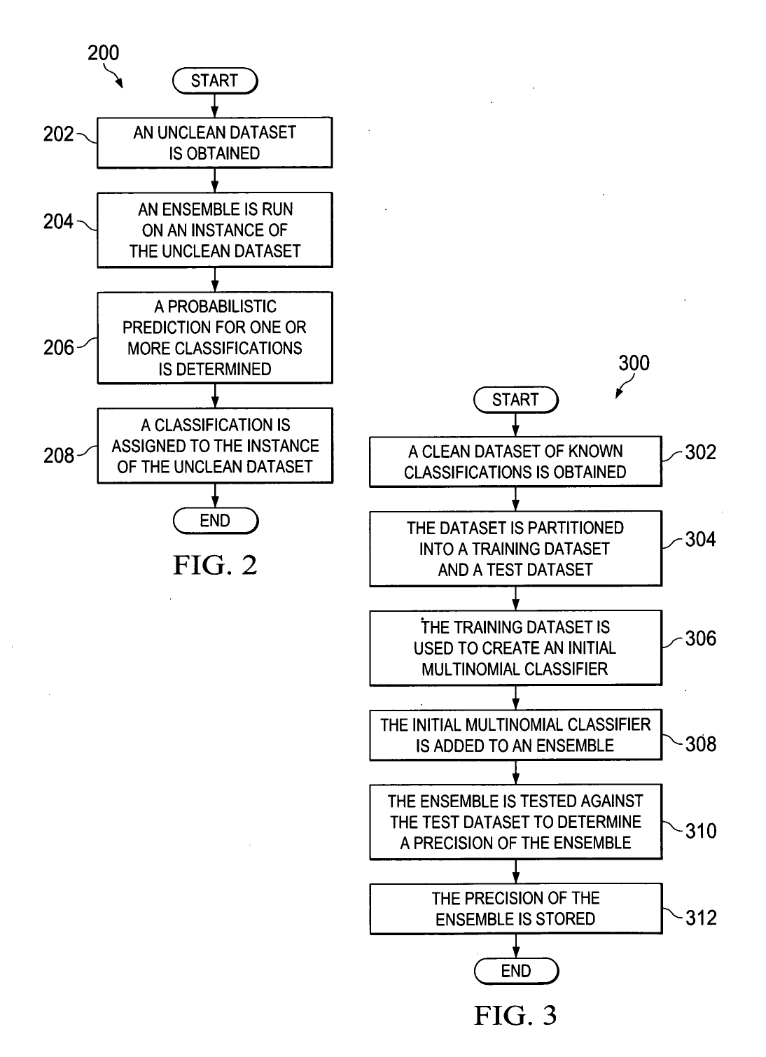

Turning to FIG. 2, FIG. 2 is an example flowchart illustrating possible operations of a flow 200 that may be associated with content classification, in accordance with an embodiment. In an embodiment, one or more operations of flow 200 may be performed by classification modules 114a and 114b, weighted forecaster modules 126a and 126b, and relabel modules 128a and 128b. At 202, an unclean dataset is obtained or otherwise identified. At 204, an ensemble is ran on an instance of the unclean dataset. At 206, a probabilistic prediction for one or more classifications is determined. For example, weighted forecaster module 126a can use the results from ensemble 124a and make a probabilistic prediction for one or more classifications that can be used to be associated with the instance. At 208, a classification is assigned to the instance of the unclean dataset.

Turning to FIG. 3, FIG. 3 is an example flowchart illustrating possible operations of a flow 300 that may be associated with content classification, in accordance with an embodiment. In an embodiment, one or more operations of flow 300 may be performed by classification modules 114a and 114b, weighted forecaster modules 126a and 126b, and relabel modules 128a and 128b. At 302, a clean dataset of known classifications is obtained. At 304, the dataset is partitioned into a training dataset and a test dataset. At 306, the training dataset is used to create an initial multinomial classifier. At 308, the initial multinomial classifier is added to an ensemble. At 310, the ensemble is tested against the test database to determine a precision of the ensemble. At 312, the precision of the ensemble is stored. For example, the precision of ensemble 124a may be stored as precision 134a.

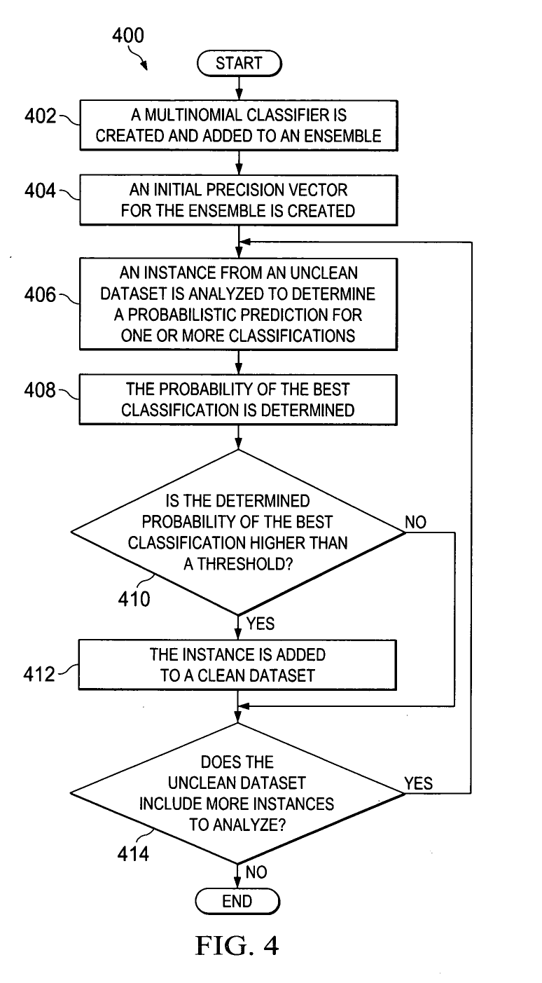

Turning to FIG. 4, FIG. 4 is an example flowchart illustrating possible operations of a flow 400 that may be associated with content classification, in accordance with an embodiment. In an embodiment, one or more operations of flow 400 may be performed by classification modules 114a and 114b, weighted forecaster modules 126a and 126b, and relabel modules 128a and 128b. At 402, a multinomial classifier is created and added to an ensemble. At 404, an initial precision vector for the ensemble is created. At 406, an instance from an unclean dataset is analyzed to determine a probabilistic prediction for one or more classifications. At 408, the probability of the best classification is determined. At 410, the system determines if the probability of the best classification is higher than a threshold. For example, the threshold may be T, T₂, or T₃ as described above. If the determined probability of the best classification is higher than the threshold, then the instance is added to a clean data set, as in 412. If the determined probability of the best classification is not higher than the threshold, then the system determines if the unclean dataset includes more instances to analyze, as in 414. If the unclean dataset includes more instances to analyze, then the system returns to 406 and an instance from an unclean dataset is analyzed to determine a probabilistic prediction for one or more classifications. If the unclean dataset does not include more instances to analyze, then the process ends.

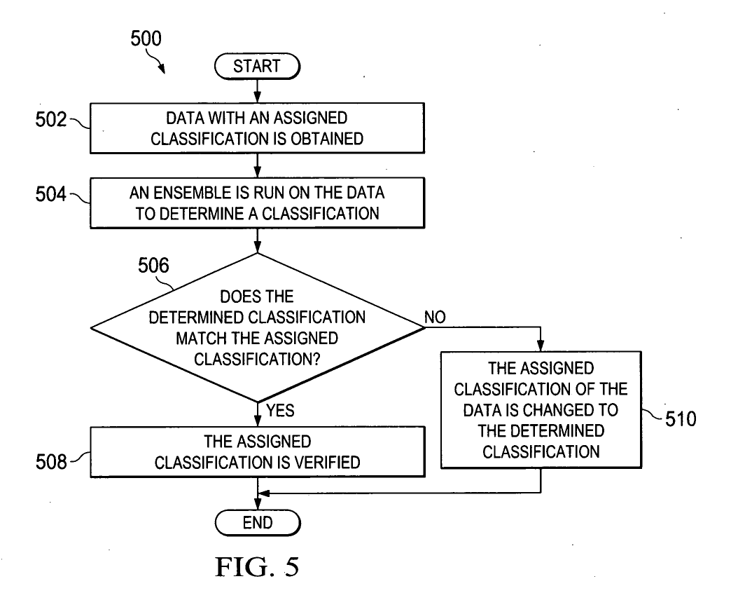

Turning to FIG. 5, FIG. 5 is an example flowchart illustrating possible operations of a flow 500 that may be associated with content classification, in accordance with an embodiment. In an embodiment, one or more operations of flow 500 may be performed by classification modules 114a and 114b, weighted forecaster modules 126a and 126b, and relabel modules 128a and 128b. At 502, data with an assigned classification is obtained or otherwise identified. At 504, an ensemble is ran on the data to determine a classification. At 506, the system determines if the determined classification matches the assigned classification. If the determined classification matches the assigned classification, then the assigned classification is verified, as in 508. If the determined classification does not match the assigned classification, then the assigned classification of the data is changed to the determined classification, as in 510.

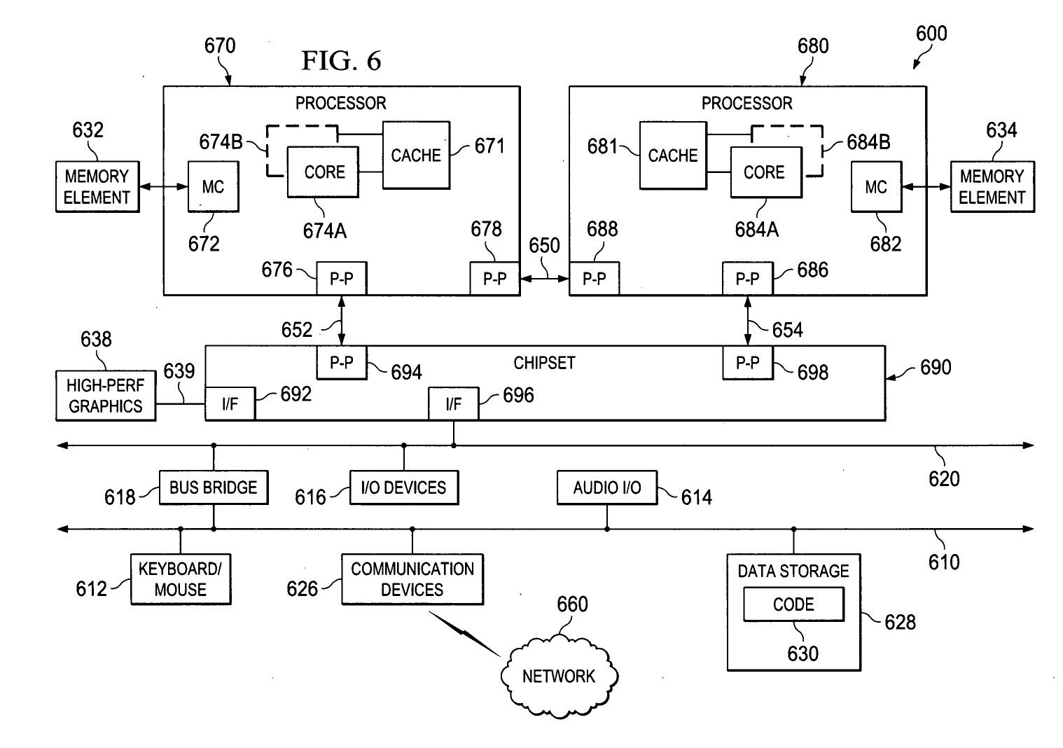

Turning to FIG. 6, FIG. 6 illustrates a computing system 600 that is arranged in a point-to-point (PtP) configuration according to an embodiment. In particular, FIG. 6 shows a system where processors, memory, and input/output devices are interconnected by a number of point-to-point interfaces. Generally, one or more of the network elements of communication system 100 may be configured in the same or similar manner as computing system 600.

As illustrated in FIG. 6, system 600 may include several processors, of which only two, processors 670 and 680, are shown for clarity. While two processors 670 and 680 are shown, it is to be understood that an embodiment of system 600 may also include only one such processor. Processors 670 and 680 may each include a set of cores (i.e., processor cores 674A and 674B and processor cores 684A and 684B) to execute multiple threads of a program. The cores may be configured to execute instruction code in a manner similar to that discussed above with reference to FIGS. 1-5. Each processor 670, 680 may include at least one shared cache 671, 681. Shared caches 671, 681 may store data (e.g., instructions) that are utilized by one or more components of processors 670, 680, such as processor cores 674 and 684.

Processors 670 and 680 may also each include integrated memory controller logic (MC) 672 and 682 to communicate with memory elements 632 and 634. Memory elements 632 and/or 634 may store various data used by processors 670 and 680. In alternative embodiments, memory controller logic 672 and 682 may be discrete logic separate from processors 670 and 680.

Processors 670 and 680 may be any type of processor and may exchange data via a point-to-point (PtP) interface 650 using point-to-point interface circuits 678 and 688, respectively. Processors 670 and 680 may each exchange data with a chipset 690 via individual point-to-point interfaces 652 and 654 using point-to-point interface circuits 676, 686, 694, and 698. Chipset 690 may also exchange data with a high-performance graphics circuit 638 via a high-performance graphics interface 639, using an interface circuit 692, which could be a PtP interface circuit. In alternative embodiments, any or all of the PtP links illustrated in FIG. 6 could be implemented as a multi-drop bus rather than a PtP link.

Chipset 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

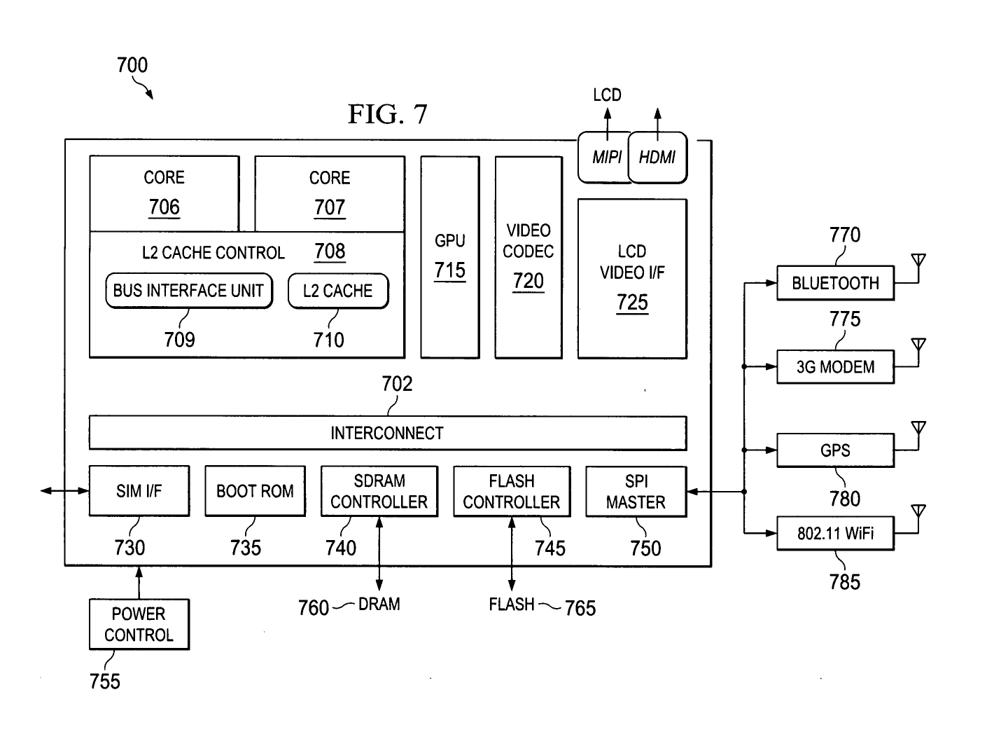

Turning to FIG. 7, FIG. 7 is a simplified block diagram associated with an example ARM ecosystem SOC 700 of the present disclosure. At least one example implementation of the present disclosure can include the content classification features discussed herein and an ARM component. For example, the example of FIG. 7 can be associated with any ARM core (e.g., A-7, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 7, ARM ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/ high-definition multimedia interface (HDMI) links that couple to an LCD.

ARM ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more embodiments include one or more communication capabilities, interfaces, and features such as instances of Bluetooth™ 770, a 3G modem 775, a global positioning system (GPS) 780, and an 802.11 Wi-Fi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

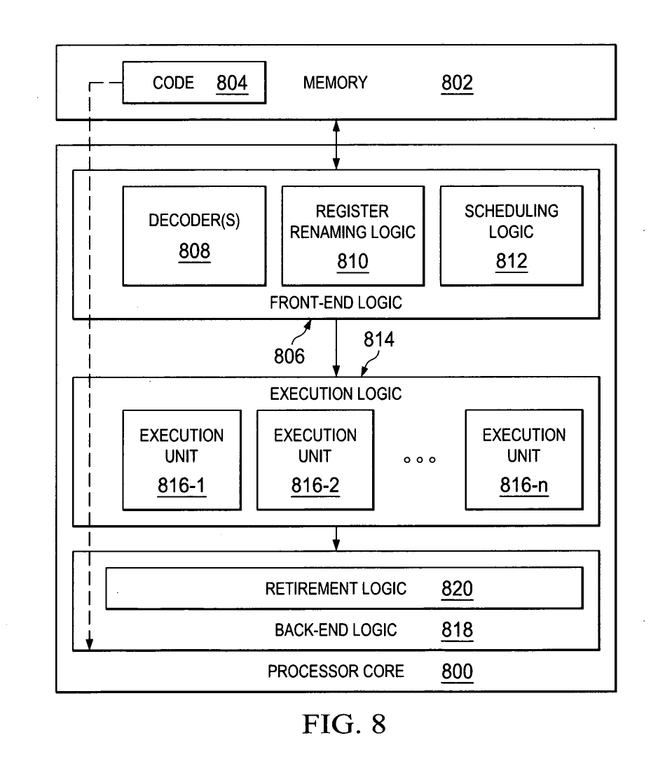

Turning to FIG. 8, FIG. 8 illustrates a processor core 800 according to an embodiment. Processor core 800 may be the core for any type of processor, such as a micro-processor, an embedded processor, a digital signal processor (DSP), a network processor, or other device to execute code. Although only one processor core 800 is illustrated in FIG. 8, a processor may alternatively include more than one of the processor core 800 illustrated in FIG. 8. For example, processor core 800 represents one example embodiment of processors cores 674a, 674b, 684a, and 684b shown and described with reference to processors 670 and 680 of FIG. 6. Processor core 800 may be a single-threaded core or, for at least one embodiment, processor core 800 may be multithreaded in that it may include more than one hardware thread context (or “logical processor”) per core.

FIG. 8 also illustrates a memory 802 coupled to processor core 800 in accordance with an embodiment. Memory 802 may be any of a wide variety of memories (including various layers of memory hierarchy) as are known or otherwise available to those of skill in the art. Memory 802 may include code 804, which may be one or more instructions, to be executed by processor core 800. Processor core 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor core 800 can also include execution logic 814 having a set of execution units 816-1 through 816-N. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor core 800 allows out of order execution but requires in order retirement of instructions. Retirement logic 820 may take a variety of known forms (e.g., re-order buffers or the like). In this manner, processor core 800 is transformed during execution of code 804, at least in terms of the output generated by the decoder, hardware registers and tables utilized by register renaming logic 810, and any registers (not shown) modified by execution logic 814.

Although not illustrated in FIG. 8, a processor may include other elements on a chip with processor core 800, at least some of which were shown and described herein with reference to FIG. 6. For example, as shown in FIG. 6, a processor may include memory control logic along with processor core 800. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagram (i.e., FIGS. 2-5) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable medium having one or more instructions that when executed by at least one processor, cause the at least one processor to analyze data using an ensemble to produce results, where the ensemble includes one or more multinomial classifiers and each multinomial classifier can assign two or more classifications to the data, assign one or more classifications to data based at least in part on the results of the analyses using the ensemble, and store the one or more classifications assigned to the data in memory.

In Example C2, the subject matter of Example C1 can optionally include where the data is located in an unclean dataset and is moved to a clean dataset after the classification is assigned.

In Example C3, the subject matter of any one of Examples C1-C2 can optionally include one or more instructions that when executed by at least one processor, cause the at least one processor to determine a previously assigned classification for the data and compare the previously assigned classification to the assigned one or more classifications.

In Example C4, the subject matter of any one of Examples C1-C3 can optionally include where the clean dataset includes a training dataset and a test dataset.

In Example C5, the subject matter of any one of Examples C1-C4 can optionally include where the training dataset is used to create a new multinomial classifier and the new multinomial classifier is added to the ensemble.

In Example C6, the subject matter of any one of Example C1-C5 can optionally include where the ensemble includes a precision vector for each of the assigned one or more classifications.

In Example C7, the subject matter of any one of Example C1-C6 can optionally include where the precision vector is used to assign a confidence each classification assigned to the data and the confidence can be compared to a threshold value.

In Example A1, an apparatus can include a memory, a classification module configured to analyze data using an ensemble to produce results, wherein the ensemble includes one or more multinomial classifiers and each multinomial classifier can assign two or more classifications to the data, assign one or more classifications to the data based on the results of the analyses using the ensemble, and store the classification in the memory.

In Example, A2, the subject matter of Example A1 can optionally include where the data is located in an unclean dataset and is moved to a clean dataset after the analysis.

In Example A3, the subject matter of any one of Examples A1-A2 can optionally include where the classification module is further configured to determine a previously assigned classification for the data and compare the previously assigned classification to the assigned one or more classifications.

In Example A4, the subject matter of any one of Examples A1-A3 can optionally include where the clean dataset includes a training dataset and a test dataset.

In Example A5, the subject matter of any one of Examples A1-A4 can optionally include where the training dataset is used to create a new multinomial classifier and the new multinomial classifier is added to the ensemble.

In Example A6, the subject matter of any one of Examples A1-A5 can optionally include where the ensemble includes a precision vector for each of the assigned one or more classifications.

In Example A7, the subject matter of any one of Examples A1-A6 can optionally include where the precision vector is used to assign a confidence each classification assigned to the data and the confidence can be compared to a threshold value.

In Example AA1, an apparatus can include a means for analyzing data using an ensemble to produce results, where the ensemble includes one or more multinomial classifiers and each multinomial classifier can assign two or more classifications to the data and means for assigning one or more classifications to the data based on the results of the analyses using the ensemble.

In Example, AA2, the subject matter of Example AA1 can optionally include where the data is located in an unclean dataset and is moved to a clean dataset after the analysis.

In Example AA3, the subject matter of any one of Examples AA1-AA2 can optionally include means for determining a previously assigned classification for the data and means for comparing the previously assigned classification to the assigned one or more classifications.

In Example AA4, the subject matter of any one of Examples AA1-AA3 can optionally include where the clean dataset includes a training dataset and a test dataset.

In Example AAS, the subject matter of any one of Examples AA1-AA4 can optionally include where the training dataset is used to create a new multinomial classifier and the new multinomial classifier is added to the ensemble.

In Example AA6, the subject matter of any one of Examples AA1-AA5 can optionally include where the ensemble includes a precision vector for each of the assigned one or more classifications.

In Example AA7, the subject matter of any one of Examples AA1-AA6 can optionally include where the precision vector is used to assign a confidence each classification assigned to the data and the confidence can be compared to a threshold value.

Example M1 is a method including analyzing data using an ensemble to produce results, where the ensemble includes one or more multinomial classifiers and each multinomial classifier can assign two or more classifications to the data, assigning one or more classifications to the data based on the results of the analyses using the ensemble, and storing the classification in the memory.

In Example M2, the subject matter of Example M1 can optionally include where the data is located in an unclean dataset and is moved to a clean dataset after the analysis.

In Example M3, the subject matter of any one of the Examples M1-M2 can optionally include determining a previously assigned classification for the data and comparing the previously assigned classification to the assigned one or more classifications.

In Example M4, the subject matter of any one of the Examples M1-M3 can optionally include where the clean dataset includes a training dataset and a test dataset.

In Example M5, the subject matter of any one of the Examples M1-M4 can optionally include where the training dataset is used to create a new multinomial classifier and the new multinomial classifier is added to the ensemble.

In Example M6, the subject matter of any one of the Examples M1-M5 can optionally include where the ensemble includes a precision vector for each of the assigned one or more classifications.

In Example M7, the subject matter of any one of the Examples M1-M6 can optionally include where the precision vector is used to assign a confidence each classification assigned to the data and the confidence can be compared to a threshold value.

Example S1 is a system for content classification, the system including memory, a classification module configured for analyzing data using an ensemble to produce results, where the ensemble includes one or more multinomial classifiers and each multinomial classifier can assign two or more classifications to the data, assigning a classification to the data based on the results of the analyses using the ensemble, and storing the classification in the memory.

In Example S2, the subject matter of Example S1 can optionally include where the classification module is further configured for determining a previously assigned classification for the data and comparing the previously assigned classification to the assigned classification.

In Example S3, the subject matter of any one of Examples S1 and S2 can optionally include where the clean dataset includes a training dataset and a test dataset.

In Example S3, the subject matter of any one of Examples S1 and S2 can optionally include where the training dataset is used to create a new multinomial classifier and the new multinomial classifier is added to the ensemble.

Example X1 is a machine-readable storage medium including machine-readable instructions to implement a method or realize an apparatus as in any one of the Examples A1-A8, or M1-M7. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that when executed by at least one processor, cause the at least one processor to:
analyze data using an ensemble to produce results, wherein the ensemble includes one or more multinomial classifiers and each multinomial classifier can assign two or more classifications to the data;
assign one or more classifications to the data based, at least in part, on the results of the analyses using the ensemble; and
store the one or more classifications assigned to the data in memory.

2. The at least one machine readable medium of claim 1, wherein the data is located in an unclean dataset and is moved to a clean dataset after the classification is assigned.

3. The at least one machine readable medium of claim 1, comprising one or more instructions that when executed by at least one processor, further cause the at least one processor to:
determine a previously assigned classification for the data; and
compare the previously assigned classification to the assigned one or more classifications.

4. The at least one machine readable medium of claim 1, wherein the clean dataset includes a training dataset and a test dataset.

5. The at least one machine readable medium of claim 4, wherein the training dataset is used to create a new multinomial classifier and the new multinomial classifier is added to the ensemble.

6. The at least one machine readable medium of claim 1, wherein the ensemble includes a precision vector for each of the assigned one or more classifications.

7. The at least one machine readable medium of claim 6, wherein the precision vector is used to assign a confidence to each classification assigned to the data and the confidence can be compared to a threshold value.

8. An apparatus comprising:
memory; and
a classification module configured to:
analyze data using an ensemble to produce results, wherein the ensemble includes one or more multinomial classifiers and each multinomial classifier can assign two or more classifications to the data; and
assign one or more classifications to the data based, at least in part, on the results of the analyses using the ensemble; and
store the classification in the memory.

9. The apparatus of claim 8, wherein the data is located in an unclean dataset and is moved to a clean dataset after the classification is assigned.

10. The apparatus of claim 8, wherein the classification module is further configured to:
determine a previously assigned classification for the data; and
compare the previously assigned classification to the assigned one or more classifications.

11. The apparatus of claim 8, wherein the clean dataset includes a training dataset and a test dataset.

12. The apparatus of claim 11, wherein the training dataset is used to create a new multinomial classifier and the new multinomial classifier is added to the ensemble.

13. The apparatus of claim 8, wherein the ensemble includes a precision vector for each of the assigned one or more classifications.

14. The apparatus of claim 13, wherein the precision vector is used to assign a confidence to each classification assigned to the data and the confidence can be compared to a threshold value.

15. A method comprising:
analyzing data using an ensemble to produce results, wherein the ensemble includes one or more multinomial classifiers and each multinomial classifier can assign two or more classifications to the data;
assigning one or more classifications to the data based, at least in part, on the results of the analyses using the ensemble; and
storing the assigned one or more classifications in memory.

16. The method of claim 15, wherein the data is located in an unclean dataset and is moved to a clean dataset after the classification is assigned.

17. The method of claim 15, further comprising:
determining a previously assigned classification for the data; and
comparing the previously assigned classification to the assigned one or more classifications.

18. The method of claim 15, wherein the clean dataset includes a training dataset and a test dataset.

19. The method of claim 15, wherein the training dataset is used to create a new multinomial classifier and the new multinomial classifier is added to the ensemble.

20. The method of claim 15, wherein the ensemble includes a precision vector for each of the assigned one or more classifications.

21. The method of claim 15, wherein the precision vector is used to assign a confidence to each classification assigned to the data and the confidence can be compared to a threshold value.

22. A system for content classification, the system comprising:
memory; and
a classification module configured for:
analyzing data using an ensemble to produce results, wherein the ensemble includes one or more multinomial classifiers and each multinomial classifier can assign two or more classifications to the data;
assigning a classification to the data based, at least in part, on the results of the analyses using the ensemble; and
storing the assigned classification in the memory.

23. The system of claim 22, wherein the classification module is further configured for:
determining a previously assigned classification for the data; and
comparing the previously assigned classification to the assigned classification.

24. The system of claim 22, wherein the clean dataset includes a training dataset and a test dataset.

25. The system of claim 24, wherein the training dataset is used to create a new multinomial classifier and the new multinomial classifier is added to the ensemble.
